(19) United States
(12) Patent Application Publication
(10) Pub. No.: US 2003/0228873 A1
(43) Pub. Date: Dec. 11, 2003

(54) Portable terminal and position information conversion system

(75) Inventor: Yoshihisa Manzen, Tokyo (JP)

Correspondence Address: FOLEY AND LARDNER, SUITE 500, 3000 K STREET NW, WASHINGTON, DC, 20007, US

(73) Assignee: NEC CORPORATION

(21) Appl. No.: 10/455,418

(22) Filed: Jun. 6, 2003

(30) Foreign Application Priority Data
Jun. 10, 2002 (JP) 2002-168695

(51) Int. Cl. H04Q 7/20

(52) U.S. Cl. 455/456.3; 455/456.1; 455/466

(57) ABSTRACT

The present invention provides a portable terminal that can provide a user with current-position related information without installing a large-capacity memory unit and a high-speed operation unit and a position information conversion system that reduces the load of user's information search processing and provides user-desired current-position related information speedily.

### BACKGROUND OF THE INVENTION

1. Field of the Invention

The present invention relates to a method for providing a user with information related to a particular current position based on information on the position, and more particularly to a portable terminal and a position information conversion system that convert current position information to related information based on a conversion rule set by a user in advance.

2. Description of Related Art

Recently, as a circuit for implementing the position calculation function becomes more compact and its position calculation sensitivity/accuracy improves, a portable terminal user can obtain “current position information” whenever the user wishes and wherever the user is.

To calculate the current position of a portable terminal, the “GPS (Global Positioning System)” function is usually used to measure electric wave signals from the GPS satellites to identify the current position. A “mobile communication terminal”, one of portable terminals communicating over a mobile communication network, can identify the current position by identifying the base station cell to which the terminal belongs.

Information obtained through the position calculation function is only information indicating the current position (for example, latitude and longitude). Therefore, to provide the user with position related information based on position information, it is necessary to extract information from databases and so on.

FIG. 1 shows a position information service system in the prior art in which a mobile communication network is used. This system comprises a position calculation function (PCF) equipped cellular phone 100 and a contents server 200 and a map database server 300 which are on a network.

The PCF-equipped cellular phone 100 comprises a position calculation function unit 101 and a display/output function unit 102.

FIG. 2 shows a sequence of operations in this system. This figure shows how the PCF-equipped cellular phone 100 provides the user with map information, registered with the map database server 300, based on current position information obtained by the position calculation function 101.

The PCF-equipped cellular phone 100 uses the position calculation function unit 101 to obtain current position information (step S801) and sends the obtained position information to the contents server 200. The contents server 200 obtains the current position information from the PCF-equipped cellular phone 100 (step S802) and, based on the information, obtains map information from the map data base server 300 (step S803). The contents server 200 sends the obtained map information to the PCF-equipped cellular phone 100 (step S804). The PCF-equipped cellular phone 100 obtains map information from the contents server 200 (step S805), and the display/output function unit 102 displays this information to the user using display means not shown (step S806).

The PCF-equipped cellular phone 100 performs the operation described above to provide the user with a map, which covers the current position and its neighboring areas, based on the current position information obtained by the position calculation function unit 101.

FIG. 3 shows a sequence of operations in the system described above. The figure shows how the PCF-equipped cellular phone 100 provides the user with current-position related information, registered with the map database 300, based on the current position information obtained by the position calculation function unit 101.

The PCF-equipped cellular phone 100 uses the position calculation function unit 101 to obtain current position information (step S901) and sends the obtained position information to the contents server 200. The contents server 200 obtains the current position information sent from the PCF-equipped cellular phone 100 (step S902). The PCF-equipped cellular phone 100 also sends a user-specified search condition to the contents server 200 (step S903). The contents server 200 obtains the search condition from the PCF-equipped cellular phone 100 (step S904).

The contents server 200 searches the map database 300 for the current-position related information based on the position information and the search condition obtained from the PCF-equipped cellular phone 100 (step S905) and sends the search result back to the PCF-equipped cellular phone 100. The PCF-equipped cellular phone 100 receives the current-position related information from the contents server 200 (step S906) The display/output function unit 102 displays the information using the display means not shown or accumulates and saves the information in the memory for use by the user (step S907).

As described above, with the PCF-equipped cellular phone in the prior art, the user specifies a search condition for the database, which has been built using map data, to obtain “current-position related information” (map, address, telephone number, store name, nearest station name, and so on) based on “current position information”.

However, to build a database using map data, a huge amount of information must be in a memory unit and, in addition, necessary information must be extracted from the stored information. It is difficult for a portable terminal, which must be compact in size, light in weight, and low in power consumption, to have a high-capacity memory unit and a high-speed operation unit.

When the terminal is a mobile communication terminal with the position information detection function, current-position related information may be presented to the user based on position information by sending current position information to a server connected via the mobile communication network, requesting the server to search for the information, and sending the result back to the mobile communication terminal. In this case, a map-data based database, if used, would take long for server to execute search processing. Therefore, not only the user cannot obtain information quickly but also the communication cost increases.

### SUMMARY OF THE INVENTION

In view of the foregoing, it is an object of the present invention to provide a portable terminal capable of providing the user with related information based on “current position information” without installing a large-capacity memory unit or a high-speed operation unit on the terminal. It is another object of the present invention to provide a position information conversion system that can reduce the search processing of the server and quickly present current-position related information desired by the user.

To achieve the above objects, there is provided a portable terminal in a first embodiment of the present invention that converts position information on the terminal to an execution instruction executing a predetermined operation associated with the position information. The portable terminal comprises a memory circuit in which at least one conversion rule group for converting the position information to the execution instruction is stored; an operation circuit that allows a user to select a conversion rule group to be applied to the conversion from the position information to the execution instruction; a position calculation function circuit that obtains current position information; a position information conversion circuit that performs processing of a conversion rule, included in the selected conversion rule group and related to the current position information, to generate the execution instruction; and a display output function circuit that executes an operation according to the generated execution instruction.

In the first embodiment of the present invention, the conversion rule group is preferably a collection of conversion processing corresponding to each cell of a matrix based on a position calculation unit of the position information and the position information conversion circuit preferably performs the processing of a conversion rule of a cell corresponding to the current position information to generate the execution instruction. Preferably, one of the conversion rule groups causes the position information conversion circuit to generate an execution instruction that presents information on a station of transportation facilities nearest to the user.

Preferably, one of the conversion rule groups causes the position information conversion circuit to generate an execution instruction that presents information on a landmark, including an intersection, an interchange, and a parking area, nearest to the user. Preferably, one of the conversion rule groups causes the position information conversion circuit to generate an execution instruction that changes a terminal setting based on the current position information.

To achieve the above objects, there is provided a position information conversion system in a second embodiment of the present invention that comprises a portable terminal executing a predetermined operation; a contents server connected to the portable terminal via a mobile communication network; and a position information conversion server connected to the contents server and having a storage unit in which at least one conversion rule group is stored for use in generating an execution instruction executing the predetermined operation based on position information on the portable terminal, wherein the portable terminal comprises a sending/receiving circuit that sends or receive information via the mobile communication network, that sends selection information indicating a conversion rule group selected by a user to the contents server, and that sends current position information to the contents server; an operation circuit which allows the user to select one of the conversion rule groups; a position calculation function circuit that obtains the current position information; and a display output function circuit that executes an operation in response to the execution instruction received from the contents server, wherein the contents server comprises a sending/receiving unit that obtains the current position information from the portable terminal and sends the execution instruction back to the portable terminal, and wherein the position information conversion server comprises a position information conversion circuit that reads one of conversion rule groups from the storage unit based on the selection information and, from the conversion rule groups that were set, reads a conversion rule related to the current position information from the storage unit for generating the execution instruction.

In the second embodiment of the present invention, the conversion rule group is preferably a collection of conversion processing corresponding to each cell of a matrix based on a position calculation unit of the position information and the position information conversion circuit preferably performs the processing of a conversion rule of a cell corresponding to the current position information to generate the execution instruction. Preferably, one of the conversion rule groups causes the position information conversion circuit to generate an execution instruction that presents information on a station of transportation facilities nearest to the user. Preferably, one of the conversion rule groups causes the position information conversion circuit to generate an execution instruction that presents information on a landmark, including an intersection, an interchange, and a parking area, to the user. Preferably, one of the conversion rule groups causes the position information conversion circuit to generate an execution instruction that changes a terminal setting of the portable terminal based on the current position information.

To achieve the above objects, there is provided a position information conversion system in a third embodiment of the present invention that comprises a position information conversion server connected to a network; a contents server connected to the position information conversion server; and a portable terminal connected to the contents server over a mobile communication network and having means for storing at least one of conversion rule groups each of which converts position information to a predetermined-operation execution instruction, wherein the portable terminal comprises a sending/receiving circuit that sends and receives information over the mobile communication network; an operation circuit that allows a user to select one of the conversion rule groups; a memory circuit that stores the conversion rule group obtained from the contents server; a position calculation function circuit that obtains current position information; a position information conversion circuit that performs processing of a conversion rule, included in the selected conversion rule groups and related to the current position information of the selected conversion rule group, for generating the execution instruction; and a display/output function circuit that executes an operation according to the generated execution instruction, wherein the position information conversion server comprises a memory unit in which at least one of the conversion rule groups is stored, and wherein the contents server comprises a sending/receiving unit that reads the conversion rule group, requested by the portable terminal, from the position information conversion server and sends the conversion rule group to the portable terminal.

In the third embodiment of the present invention, the conversion rule group is preferably a collection of conversion processing corresponding to each cell of a matrix based on a position calculation unit of the position information and the position information conversion circuit preferably performs the processing of a conversion rule of a cell corresponding to the current position information to generate the execution instruction. Preferably, one of the conversion rule groups causes the position information conversion circuit to generate an execution instruction that presents information on a station of transportation facilities nearest to the user. Preferably, one of the conversion rule groups causes the position information conversion circuit to generate an execution instruction that presents information on a landmark, including an intersection, an interchange, and a parking area, to the user. Preferably, one of the conversion rule groups causes the position information conversion circuit to generate an execution instruction that changes a terminal setting based on the current position information.

### BRIEF DESCRIPTION OF THE DRAWINGS

The above and other objects, features and advantages of the present invention will become more apparent from the following detailed description when taken in conjunction with the accompanying drawings wherein:

Fig. 1 is a diagram showing the configuration of a position information conversion system in the prior art;

FIG. 2 is a diagram showing an example of the operation of the position information conversion system in the prior art;

FIG. 3 is a diagram showing another example of the operation of the position information conversion system in the prior art;

FIG. 4 is a block diagram showing the configuration of a portable terminal in a first embodiment that is a preferred embodiment of the present invention;

FIG. 5 is a diagram showing an example of the operation of the portable terminal in the first embodiment of the present invention;

FIG. 6 is a diagram showing an example of conversion rules;

FIG. 7 is a diagram showing an example of the conversion rules;

FIG. 8 is a diagram showing an example of the conversion rules;

FIG. 9 is a diagram showing another example of the conversion rules;

FIG. 10 is a diagram showing another example of the conversion rules;

Fig. 11 is a diagram showing the configuration of a position information conversion system in a second embodiment that is a preferred embodiment of the present invention;

FIG. 12 is a diagram showing an example of the operation of the position information conversion system in the second embodiment;

FIG. 13 is a diagram showing the configuration of a position information conversion system in a third embodiment that is a preferred embodiment of the present invention; and

FIG. 14 is a diagram showing an example of the operation of the position information conversion system in the third embodiment.

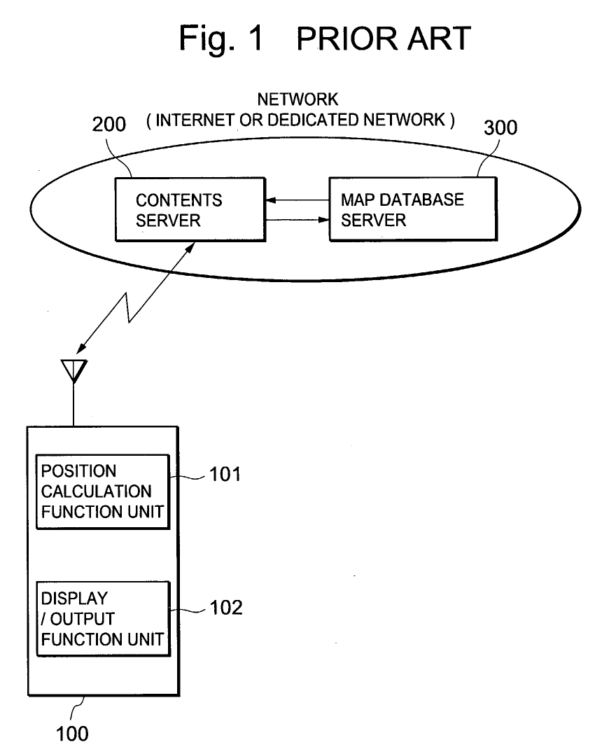

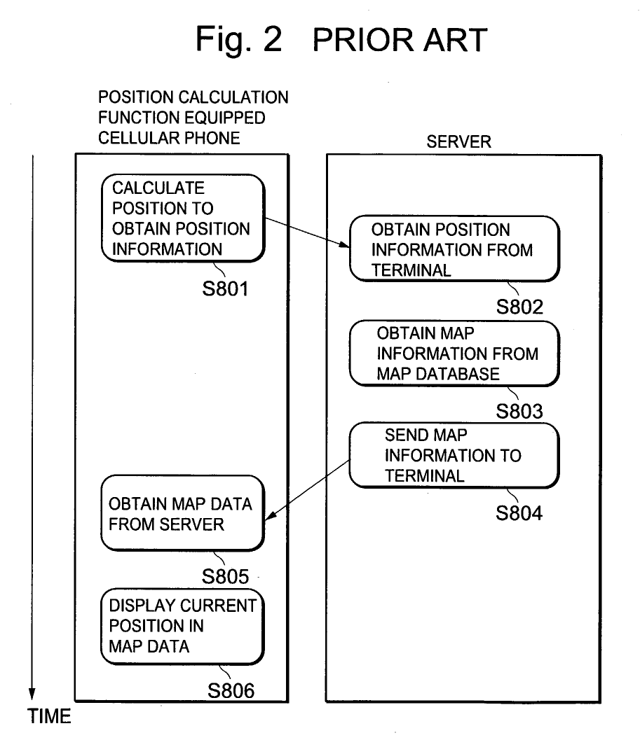

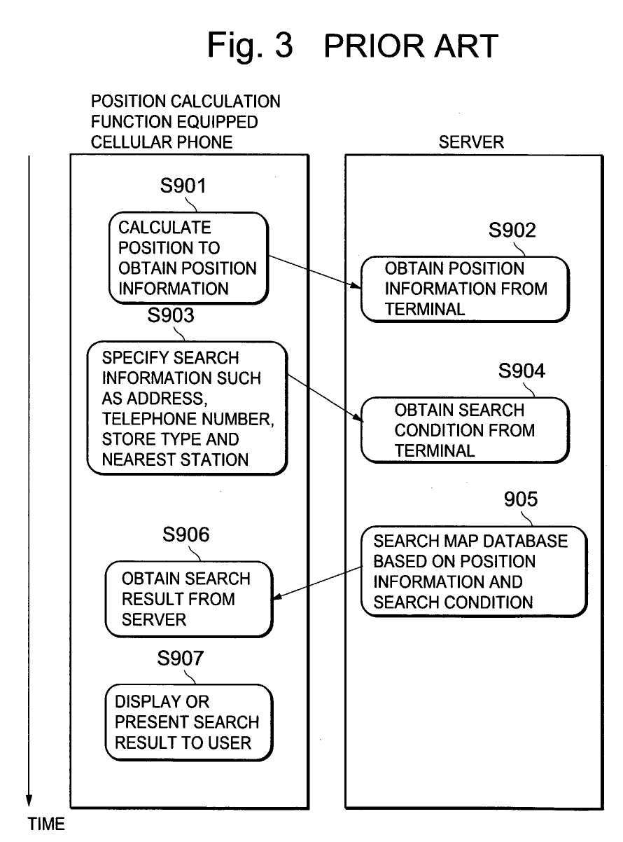

### DETAILED DESCRIPTION OF THE PREFERRED EMBODIMENTS

[First Embodiment]

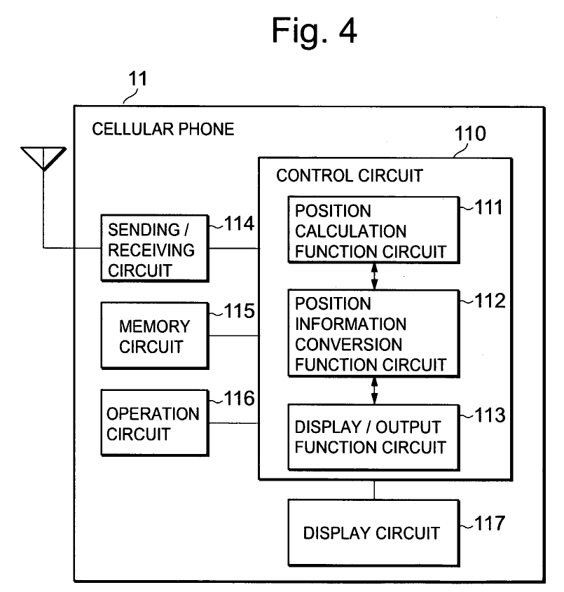

A first embodiment, which is a preferred embodiment of the present invention, will be described. FIG. 4 shows a cellular phone with the position calculation function according to the present invention. A cellular phone 11 comprises a sending/receiving circuit 114, a memory circuit 115, an operation circuit 116, a display circuit 117, a control circuit 110, and a processing circuit, not shown, that controls the whole of the cellular phone. The control circuit 110 comprises a position calculation function circuit 111, a position information conversion function circuit 112, and a display/output function circuit 113.

The position calculation function circuit 111 obtains the current position of the terminal as latitude and longitude information. The position information conversion function circuit 112 converts the current position information to a predetermined-operation execution instruction according to a conversion rule that will be described later. In response to an execution instruction, the display/output function circuit 113 displays or presents the current-position related information to the user using the-display circuit 117.

### OPERATION EXAMPLE 1

The operation of the cellular phone in this embodiment will be described.

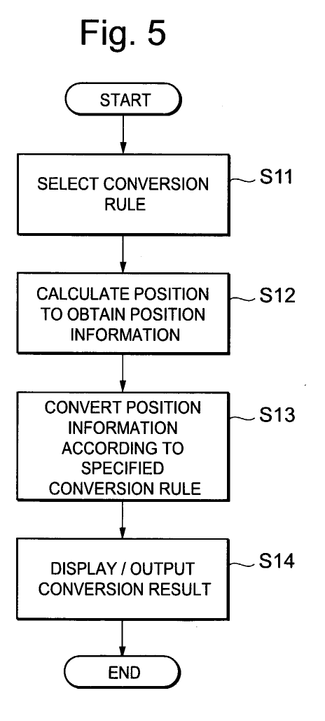

FIG. 5 shows an example of the operation of the cellular phone 11.

First, the user of the cellular phone 11 selects a position information conversion rule in advance (step S11). When the user selects to use a conversion rule, the position calculation function circuit 111 obtains the current position of the terminal as latitude and longitude information (step S12). This information is sent to the position information conversion function circuit 112. The position information conversion function circuit 112 converts the latitude and longitude information to a predetermined-operation execution instruction (for example, an instruction that displays the current-position related information such as a place name or a station name) according to the conversion rule that has been specified (step S13). The cellular phone 11 executes an operation according to the execution instruction obtained as a result of the conversion (for example, the display/output function circuit 113 uses the display circuit 117 to present current-position related information to the user) (step S14).

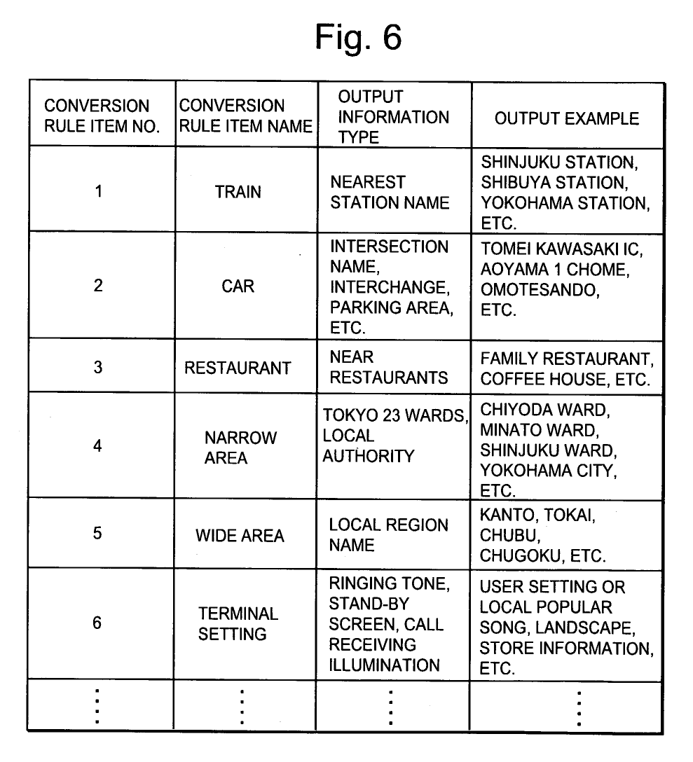

The operation of the position information conversion function circuit 112 will be described using an example of a conversion rule. FIG. 6 shows an example of items of conversion rules that may be applied to the cellular phone 11. In step S11, the user selects a conversion rule item, related to information he or she wants, from many conversion rule items.

For example, when the user selects the conversion rule for “train”, the position information conversion function circuit 112 converts the current position information, obtained by the position calculation function circuit 111 in step S12, to an instruction that displays the nearest station (station name, train stop name, etc.).

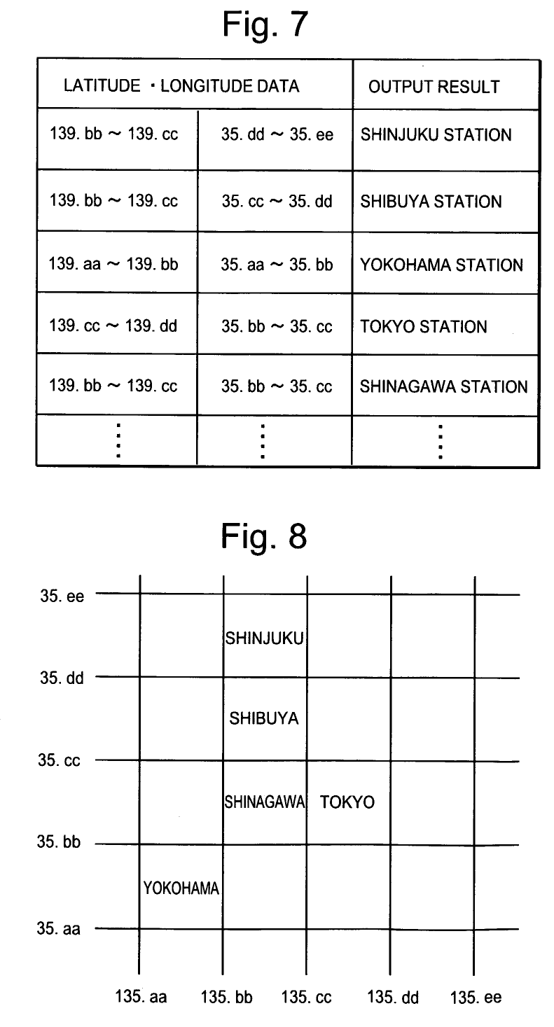

As shown in FIG. 7 and FIG. 8, each conversion rules are arranged in a matrix of a range by latitude values and longitude values. Therefore, if the user specifies a destination in advance to find the station name of the destination from the nearest station using the transfer guide information, the user can obtain desired information without entering the name of the nearest station because it is found by the position calculation function.

When the cellular phone 11 obtains current position information using a mobile communication network, the conversion rule is a matrix corresponding to the base station cells.

When the user selects the conversion rule for “car”, the information the user requires during driving is information on the nearest intersection or information on the interchanges or parking areas while driving on an express highway. Therefore, when the conversion rule for “car” is selected, the cellular phone 11 uses the position information conversion function circuit 112 to convert the current position information, obtained by the position calculation function circuit 111 in step S12, to an instruction that displays the nearest intersection, interchange, or parking area.

Like the conversion rule for “car”, the conversion rule for “train” is also in a matrix of a range of simple latitude and longitude values. Therefore, if the user specifies a destination in advance, the cellular phone 11 can search for a route using the current position information obtained by the position calculation function circuit 111.

The user who wants to obtain information on restaurants can select the conversion rule “restaurant” to obtain information on the near restaurants.

Also, the user of the cellular phone 11 can select the conversion rule for “wide area” to know the current position roughly. Conversely, the user can select the conversion rule for “narrow area” to know the current position precisely.

### OPERATION EXAMPLE 2

The second operation example of the cellular phone 11 will be described. This operation is executed to change the setting of the terminal based on the current position information and is registered with the position information conversion function circuit 112 as one of conversion rules.

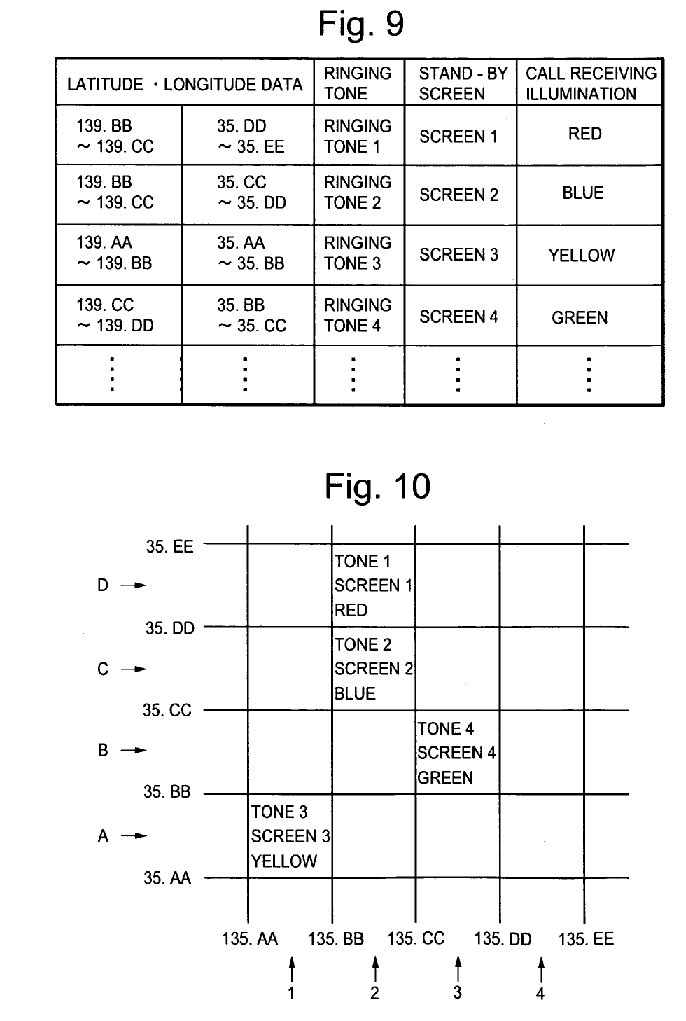

FIG. 9 and FIG. 10 show the rule for changing the setting of the terminal based on the latitude and longitude of the current position. As shown in the figures, the setting pattern of the cellular phone is associated with a matrix of a range of latitude and longitude values.

When the user selects the conversion rule for “terminal setting” in step S11, the cellular phone 11 changes the setting of the terminal based on the position information obtained by the position calculation function circuit 111 in step S12 and on the rule for changing the setting described above.

For example, when it is found as a result of position calculation that the user is in area D2, the position information conversion function circuit 112 generates an execution instruction that sets the ringing tone to melody 1, the standby screen to screen 1, and call receiving illumination to red and requests the cellular phone 11 to change the setting. Similarly, when it is found as a result of position calculation that the user is in area A1, the position information conversion function circuit 112 generates an execution instruction that sets the ringing tone to melody 3, the standby screen to screen 3, and call receiving illumination to yellow and requests the cellular phone 11 to change the setting.

The cellular phone 11 can automatically calculate current position information using the position calculation function circuit 111 (for example, every minute or at a predetermined interval) to automatically switch the setting that rings a favorite ringing tone at home and turns off the ringing tone in the office (activates the vibrator).

As described above, the cellular phone 11 has conversion rules each of which converts current position information, obtained by the position calculation function circuit 111, to a predetermined-operation execution instruction. When the cellular phone 11 provides the user with current-position related information, the cellular phone 11 uses those conversion rules to convert current position information, indicated by a latitude and a longitude, to current-position related information without using a database based on map data and then provides the user with the converted result. In other words, the cellular phone 11 converts current position information to a display instruction that displays current-position related information based on a conversion rule specified by the user in advance, thus eliminating the need for a large-capacity memory unit or a high-speed operation unit.

The cellular phone 11 converts position information to a display instruction that displays current-position related information. Therefore, current-position related information may be presented to the user quickly with no communication cost involved in conversion.

In addition, the cellular phone 11 not only provides the user with current-position related information based on current position information but also uses current position information for other purposes; for example, the cellular phone 11 uses current position information to change the setting of the terminal.

[Second Embodiment]

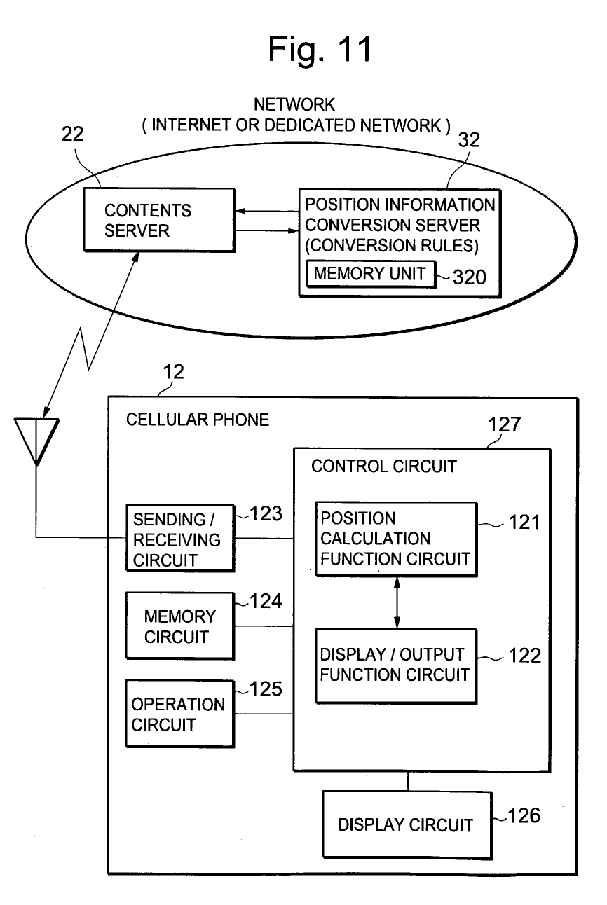

A second embodiment, which is a preferred embodiment of the present invention, will be described. FIG. 11 shows a position information conversion system in this embodiment. This system comprises a cellular phone 12, a contents server 22, and a position information conversion server 32.

The cellular phone 12 comprises a sending/receiving circuit 123, a memory circuit 124, an operation circuit 125, a display circuit 126, a control circuit 127, and a processing circuit, not shown, that controls the whole of the cellular phone 12. The control circuit 127 comprises a position calculation function circuit 121 and a display/output function circuit 122. The cellular phone 12 is connected to the contents server 22 on a network via a wireless communication network. The contents server 22 is connected to the position information conversion server 32 on the network.

The contents server 22 sets a conversion rule item in the position information conversion server 32 and instructs it to execute conversion. In other words, the contents server 22 holds information on a user-selected conversion rule, calls a user-selected conversion rule from a memory unit 320 of the position information conversion server 32, and requests the position information conversion server 32 to convert current position information to a predetermined-operation execution instruction.

The position information conversion server 32 converts current position information to a predetermined-operation execution instruction based on the user-specified conversion rule.

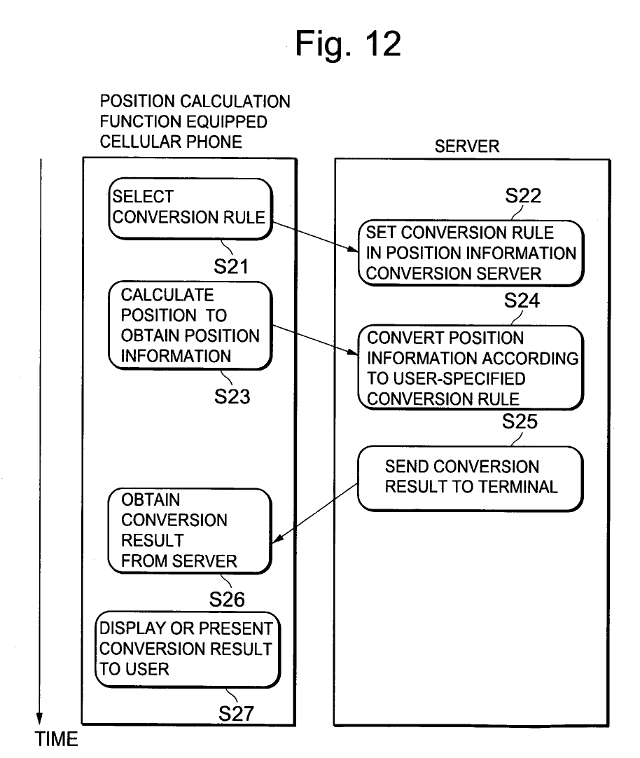

The operation of the position information conversion system in this embodiment will be described. FIG. 12 shows an example of the operation of the position information conversion system.

First, the user of the cellular phone 12 selects a conversion rule item for position information in advance (step S21). The information on the user-selected conversion rule is sent to the contents server 22 via the mobile communication network. This conversion rule is set as the conversion rule that will be used when current position information is converted to a predetermined-operation execution instruction (step S22).

When the user uses the conversion rule, the position calculation function circuit 121 obtains the current position of the cellular phone 12 as the latitude and the longitude (step S23). The cellular phone 12 sends this information to the contents server 22 via the mobile communication network. The contents server 22 sends the received current position information to the position information conversion server 32 and requests it to convert the current position information using the conversion rule that was set.

The position information conversion server 32 converts the current position information, indicated by the latitude and the longitude, to a predetermined-operation execution instruction based on the conversion rule that was set (step S24) For example, the position information conversion server 32 reads current-position related information related to the current position from storage means, not shown, based on the conversion rule that was set in advance and generates an execution instruction that displays this information. The position information conversion server 32 sends the predetermined-operation execution instruction, obtained as a result of the conversion, to the contents server 22. The contents server 22 sends the received predetermined-operation execution instruction to the cellular phone 12 (step S25).

The cellular phone 12 obtains the predetermined-operation execution instruction from the contents server 22 via the mobile communication network (step S26). The display/output function circuit 122 executes operation based on the execution instruction; for example, the display/output function circuit 122 presents the current-position related information to the user using the display circuit 126 or allows the user to change the terminal setting (step S27).

Note that conversion rules used in position information conversion in the example of operation described above are the same as those used in the cellular phone 11 in the first embodiment shown in FIG. 6. As in the first embodiment, each conversion rule is associated with a matrix of a range of latitude and longitude values.

Although the contents server 22 and the position information conversion server 32 are separate servers in the above embodiment, one server may have both functions.

As described above, the position information conversion system in this embodiment, in which conversion rules for converting current position information to a predetermined-operation execution instruction are stored in the server, eliminates the need for providing a large-capacity memory unit or a high-speed operation unit on a terminal. Another advantage is that conversion rules may be easily added or updated because they are stored in the server.

In addition, when presenting current-position related information to the user, the server uses a user-specified conversion rule to convert the position information to an instruction that displays the current-position related information. This configuration requires less time to convert current position information to current-position related information than that required by the conventional system. Therefore, the system with the configuration in which conversion rules are stored in the server requires lower communication costs and shorter conversion processing wait times than those of the conventional position information conversion system.

In addition, when the position calculation function circuit 121 obtains the current position information based on the base station cell to which it belongs (in other words, the current position information is obtained using the mobile communication network), the cellular phone uses the mobile communication network to calculate the current position and, therefore, there is no need for communication only for converting the current position information. Thus, the cellular phone that uses the mobile communication network to obtain the current position may use a configuration in which conversion rules are stored in the server, without greatly increasing the communication costs or the processing wait times.

[Third Embodiment]

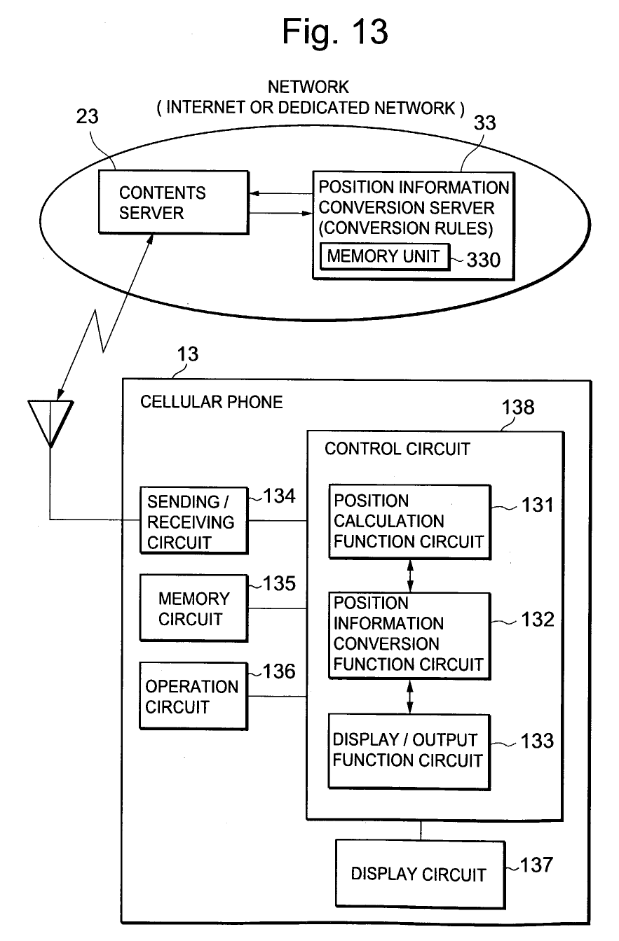

A third embodiment, which is a preferred embodiment of the present invention, will be described. FIG. 13 shows a position information conversion system in this embodiment. A cellular phone 13 comprises a sending/receiving circuit 134, a memory circuit 135, an operation circuit 136, a display circuit 137, a control circuit 138, and a processing circuit, not shown, that controls the whole of the cellular phone 13. The control circuit 138 comprises a position calculation function circuit 131, a position information conversion function circuit 132, and a display/output function circuit 133. This system differs from the position information conversion system in the second embodiment in that the cellular phone 13 has the position information conversion function circuit 132. In this embodiment, a contents server 23 reads a user-requested conversion rule from a memory unit 330 of the position information conversion server 33 and sends it to the cellular phone 13. The memory unit 330 contains at least one group of conversion rule groups.

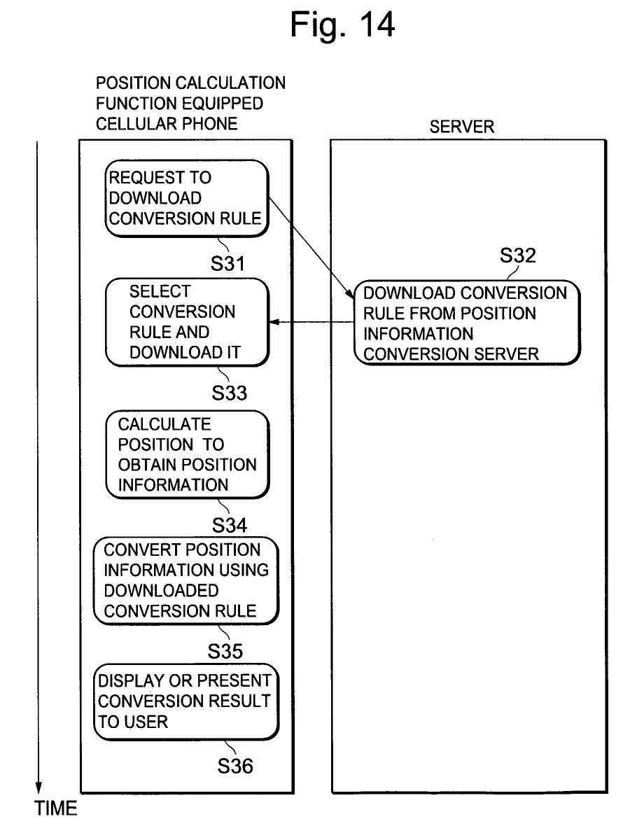

The operation of the cellular phone in this embodiment will be described. FIG. 14 shows an example of the operation of the cellular phone in this embodiment. In response to a user's input operation, the cellular phone 13 communicates with the position information conversion server 33 via a mobile communication network and the contents server 23 and requests the contents server 23 to download a conversion rule (step S31). In response to the request from the cellular phone 13, the contents server 23 reads the requested conversion rule from the position information conversion server 33 and sends it to the cellular phone 13 (step S32). The cellular phone 13 stores in the memory circuit 135 the conversion rule obtained from the position information conversion server 33 via the mobile communication network and the contents server 23 (step S33). The operation following step S34 is the same as that of the cellular phone in the first embodiment except that, when current position information is converted to a predetermined-operation execution instruction, the conversion rule downloaded from the position information conversion server 33 is used. As in the second embodiment, the position information conversion system in this embodiment may also be configured by one server that has both the function of the contents server 23 and the function of the position information conversion server 33.

As described above, the cellular phone 13 that is applied to the position information conversion system in this embodiment can obtain a conversion rule, used to convert current position information to a predetermined-operation execution instruction, by downloading it from the position information conversion server 33 and allow the user to update it. Therefore, in addition to the advantage obtained by the cellular phone 11 in the first embodiment, the cellular phone 13 allows the user to add or update a conversion rule easily. In addition, the cellular phone 13 needs only to communicate with the position information conversion server 33 only when a conversion rule is downloaded. Therefore, there is no communication cost or conversion processing wait time when the current position information is converted to a predetermined-operation execution instruction. The cellular phone 13 also allows the user to download a necessary conversion rule when contents are used.

It is to be understood that the above embodiments are an example of preferred embodiments and that the present invention is not limited to those embodiments. For example, the conversion rules shown in the above embodiments are exemplary only; other conversion rules may also be applied. Although a cellular phone with the position calculation function is used as an example in the description of the embodiments above, the present invention is not limited to cellular phones but may be applied also to other terminals such as a PHS terminal. If the configuration does not require communication to or from the server, the function to communicate with a mobile communication network need not be provided. Thus, many modifications are possible in the present invention.

As is apparent from the above description, the present invention provides a portable terminal and a position information conversion system that can provide the user with “current-position related information” generated based on “current position information” without installing a large-capacity storage unit or a high-speed operation unit. The present invention also provide a portable terminal and a position information conversion system that minimize an increase in the communication cost and in conversion processing wait time when current-position related information is provided to the user. In addition, the present invention not only provides the user with information on the current position but also allows a portable terminal to execute a predetermined operation according to the position information on the current position.

While this invention has been described in connection with certain preferred embodiments, it is to be understood that the subject matter encompassed by way of this invention is not to be limited to those specific embodiments. On the contrary, it is intended for the subject matter of the invention to include all alternatives, modifications and equivalents as can be included within the spirit and scope of the following claims.

What is claimed is:

1. A portable terminal converting position information on said terminal to an execution instruction executing a predetermined operation associated with the position information, said portable terminal comprising:
a memory circuit in which conversion rule groups for converting the position information to the execution instruction is stored;
an operation circuit that allows a user to select a conversion rule group to be applied to the conversion from the position information to the execution instruction;
a position calculation function circuit that obtains current position information;
a position information conversion circuit that performs processing of a conversion rule, included in the selected conversion rule group and related to the current position information, to generate the execution instruction; and
a display output function circuit that executes an operation according to the generated execution instruction.

2. The portable terminal according to claim 1,
wherein the conversion rule group is a collection of conversion processing corresponding to each cell of a-matrix based on a position calculation unit of the position information and
wherein said position information conversion circuit performs the processing of a conversion rule of a cell corresponding to the current position information to generate the execution instruction.

3. The portable terminal according to claim 1,
wherein one of the conversion rule groups causes said position information conversion circuit to generate an execution instruction that presents information on a station of transportation facilities nearest to the user.

4. The portable terminal according to claim 2,
wherein one of the conversion rule groups causes said position information conversion circuit to generate an execution instruction that presents information on a station of transportation facilities nearest to the user.

5. The portable terminal according to claim 1,
wherein one of the conversion rule groups causes said position information conversion circuit to generate an execution instruction that presents information on a landmark, including an intersection, an interchange, and a parking area, nearest to the user.

6. The portable terminal according to claim 2,
wherein one of the conversion rule groups causes said position information conversion circuit to generate an execution instruction that presents information on a landmark, including an intersection, an interchange, and a parking area, nearest to the user.

7. The portable terminal according to claim 3,
wherein one of the conversion rule groups causes said position information conversion circuit to generate an execution instruction that presents information on a landmark, including an intersection, an interchange, and a parking area, nearest to the user.

8. The portable terminal according to claim 4,
wherein one of the conversion rule groups causes said position information conversion circuit to generate an execution instruction that presents information on a landmark, including an intersection, an interchange, and a parking area, nearest to the user.

9. The portable terminal according to claim 1,
wherein one of the conversion rule groups causes said position information conversion circuit to generate an execution instruction that changes a terminal setting based on the current position information.

10. The portable terminal according to claim 2,
wherein one of the conversion rule groups causes said position information conversion circuit to generate an execution instruction that changes a terminal setting based on the current position information.

11. The portable terminal according to claim 3,
wherein one of the conversion rule groups causes said position information conversion circuit to generate an execution instruction that changes a terminal setting based on the current position information.

12. The portable terminal according to claim 4,
wherein one of the conversion rule groups causes said position information conversion circuit to generate an execution instruction that changes a terminal setting based on the current position information.

13. The portable terminal according to claim 5,
wherein one of the conversion rule groups causes said position information conversion circuit to generate an execution instruction that changes a terminal setting based on the current position information.

14. The portable terminal according to claim 6,
wherein one of the conversion rule groups causes said position information conversion circuit to generate an execution instruction that changes a terminal setting based on the current position information.

15. The portable terminal according to claim 7,
wherein one of the conversion rule groups causes said position information conversion circuit to generate an execution instruction that changes a terminal setting based on the current position information.

16. The portable terminal according to claim 8,
wherein one of the conversion rule groups causes said position information conversion circuit to generate an execution instruction that changes a terminal setting based on the current position information.

17. A position information conversion system comprising:
a portable terminal executing a predetermined operation;
a contents server connected to said portable terminal via a mobile communication network; and
a position information conversion server connected to said contents server and having a storage unit in which at least one conversion rule group is stored for use in generating an execution instruction executing the predetermined operation based on position information on said portable terminal,
wherein said portable terminal comprises:
a sending/receiving circuit that sends or receive information via the mobile communication network, that sends selection information indicating a conversion rule group selected by a user to said contents server, and that sends current position information to said contents server;
an operation circuit which allows the user to select one of said conversion rule groups;
a position calculation function circuit that obtains the current position information; and
a display output function circuit that executes an operation in response to the execution instruction received from said contents server,
wherein said contents server comprises a sending/receiving unit that obtains the current position information from said portable terminal and sends said execution instruction back to said portable terminal, and
wherein said position information conversion server comprises a position information conversion circuit that reads one of conversion rule groups from said storage unit based on the selection information and, from the conversion rule groups that were set, reads a conversion rule related to the current position information from said storage unit for generating the execution instruction.

18. The position information conversion system according to claim 17,
wherein the conversion rule group is a collection of conversion processing corresponding to each cell of a matrix based on a position calculation unit of the position information and
wherein said position information conversion circuit performs the processing of a conversion rule of a cell corresponding to the current position information to generate the execution instruction.

19. The position information conversion system according to claim 17,
wherein one of the conversion rule groups causes said position information conversion circuit to generate an execution instruction that presents information on a station of transportation facilities nearest to the user.

20. The position information conversion system according to claim 18,
wherein one of the conversion rule groups causes said position information conversion circuit to generate an execution instruction that presents information on a station of transportation facilities nearest to the user.

21. The position information conversion system according to claim 17,
wherein one of the conversion rule groups causes said position information conversion circuit to generate an execution instruction that presents information on a landmark, including an intersection, an interchange, and a parking area, to the user.

22. The position information conversion system according to claim 18,
wherein one of the conversion rule groups causes said position information conversion circuit to generate an execution instruction that presents information on a landmark, including an intersection, an interchange, and a parking area, to the user.

23. The position information conversion system according to claim 19,
wherein one of the conversion rule groups causes said position information conversion circuit to generate an execution instruction that presents information on a landmark, including an intersection, an interchange, and a parking area, to the user.

24. The position information conversion system according to claim 20,
wherein one of the conversion rule groups causes said position information conversion circuit to generate an execution instruction that presents information on a landmark, including an intersection, an interchange, and a parking area, to the user.

25. The position information conversion system according to claim 17,
wherein one of the conversion rule groups causes said position information conversion circuit to generate an execution instruction that changes a terminal setting of said portable terminal based on the current position information.

26. The position information conversion system according to claim 18,
wherein one of the conversion rule groups causes said position information conversion circuit to generate an execution instruction that changes a terminal setting of said portable terminal based on the current position information.

27. The position information conversion system according to claim 19,
wherein one of the conversion rule groups causes said position information conversion circuit to generate an execution instruction that changes a terminal setting of said portable terminal based on the current position information.

28. The-position information conversion system according to claim 20,
wherein one of the conversion rule groups causes said position information conversion circuit to generate an execution instruction that changes a terminal setting of said portable terminal based on the current position information.

29. The position information conversion system according to claim 21,
wherein one of the conversion rule groups causes said position information conversion circuit to generate an execution instruction that changes a terminal setting of said portable terminal based on the current position information.

30. The position information conversion system according to claim 22,
wherein one of the conversion rule groups causes said position information conversion circuit to generate an execution instruction that changes a terminal setting of said portable terminal based on the current position information.

31. The position information conversion system according to claim 23,
wherein one of the conversion rule groups causes said position information conversion circuit to generate an execution instruction that changes a terminal setting of said portable terminal based on the current position information.

32. The position information conversion system according to claim 24,
wherein one of the conversion rule groups causes said position information conversion circuit to generate an execution instruction that changes a terminal setting of said portable terminal based on the current position information.

33. A position information conversion system comprising:
a position information conversion server connected to a network;
a contents server connected to said position information conversion server; and
a portable terminal connected to said contents server over a mobile communication network and having means for storing at least one of conversion rule groups each of which converts position information to a predetermined-operation execution instruction,
wherein said portable terminal comprises:
a sending/receiving circuit that sends and receives information over the mobile communication network;
an operation circuit that allows a user to select one of the conversion rule groups;
a memory circuit that stores the conversion rule group obtained from said contents server;
a position calculation function circuit that obtains current position information;
a position information conversion circuit that performs processing of a conversion rule, included in the selected conversion rule groups and related to the current position information of the selected conversion rule group, for generating the execution instruction; and
a display/output function circuit that executes an operation according to the generated execution instruction,
wherein said position information conversion server comprises a memory unit in which at least one of the conversion rule groups is stored, and
wherein said contents server comprises a sending/receiving unit that reads the conversion rule group, requested by said portable terminal, from said position information conversion server and sends the conversion rule group to said portable terminal.

34. The position information conversion system according to claim 33,
wherein the conversion rule group is a collection of conversion processing corresponding to each cell of a matrix based on a position calculation unit of the position information and
wherein said position information conversion circuit performs the processing of a conversion rule of a cell corresponding to the current position information to generate the execution instruction.

35. The position information conversion system according to claim 33,
wherein one of the conversion rule groups causes said position information conversion circuit to generate an execution instruction that presents information on a station of transportation facilities nearest to the user.

36. The position information conversion system according to claim 34,
wherein one of the conversion rule groups causes said position information conversion circuit to generate an execution instruction that presents information on a station of transportation facilities nearest to the user.

37. The position information conversion system according to claim 33,
wherein one of the conversion rule groups causes said position information conversion circuit to generate an execution instruction that presents information on a landmark, including an intersection, an interchange, and a parking area, to the user.

38. The position information conversion system according to claim 34,
wherein one of the conversion rule groups causes said position information conversion circuit to generate an execution instruction that presents information on a landmark, including an intersection, an interchange, and a parking area, to the user.

39. The position information conversion system according to claim 35,
wherein one of the conversion rule groups causes said position information conversion circuit to generate an execution instruction that presents information on a landmark, including an intersection, an interchange, and a parking area, to the user.

40. The position information conversion system according to claim 36,
wherein one of the conversion rule groups causes said position information conversion circuit to generate an execution instruction that presents information on a landmark, including an intersection, an interchange, and a parking area, to the user.

41. The position information conversion system according to claim 33,
wherein one of the conversion rule groups causes said position information conversion circuit to generate an execution instruction that changes a terminal setting based on the current position information.

42. The position information conversion system according to claim 34,
wherein one of the conversion rule groups causes said position information conversion circuit to generate an execution instruction that changes a terminal setting based on the current position information.

43. The position information conversion system according to claim 35,
wherein one of the conversion rule groups causes said position information conversion circuit to generate an execution instruction that changes a terminal setting based on the current position information.

44. The position information conversion system according to claim 36,
wherein one of the conversion rule groups causes said position information conversion circuit to generate an execution instruction that changes a terminal setting based on the current position information.

45. The position information conversion system according to claim 37,
wherein one of the conversion rule groups causes said position information conversion circuit to generate an execution instruction that changes a terminal setting based on the current position information.

46. The position information conversion system according to claim 38,
wherein one of the conversion rule groups causes said position information conversion circuit to generate an execution instruction that changes a terminal setting based on the current position information.

47. The position information conversion system according to claim 39,
wherein one of the conversion rule groups causes said position information conversion circuit to generate an execution instruction that changes a terminal setting based on the current position information.

48. The position information conversion system according to claim 40,
wherein one of the conversion rule groups causes said position information conversion circuit to generate an execution instruction that changes a terminal setting based on the current position information.
